(19) United States
(12) Patent Application Publication
(10) Pub. No.: US 2026/0078984 A1
(43) Pub. Date: Mar. 19, 2026

(54) MULTIPLE LINEAR ARRAY SEEKER

(71) Applicant: BAE SYSTEMS Information and Electronic Systems Integration Inc., Nashua, NH (US)

(72) Inventors: Robert D. Frey, JR., Bolton, MA (US); Robin L. Brown, Leominster, MA (US)

(73) Assignee: BAE SYSTEMS Information and Electronic Systems Integration Inc., Nashua, NH (US)

(21) Appl. No.: 18/886,483

(22) Filed: Sep. 16, 2024

(51) Int. Cl. F41G 7/22; G02B 6/12; G02B 6/293

(52) U.S. Cl. CPC F41G 7/226; F41G 7/2293; G02B 6/12; G02B 6/29389

(57) ABSTRACT

An optical seeker assembly and method, used in a semiautomatic laser seeker system in a precision guided munition, improve detection sensitivity, increase detection speed, and reduce calculation overhead includes at least two linear optical detector arrays, where the detection signals with the maximum summed intensity, from among pairs of adjacent pixel detectors, are selected for each linear optical detector array, and the signal with the maximum summed intensity, from among the selected signals, for pairs of adjacent linear optical detector arrays is selected, and compared to a threshold value that is set to produce a constant false alarm rate, to produce a detection signal that is then confirmed as a confirmed detection through process of correlation with other recent detection signals.

### FIELD OF THE DISCLOSURE

The present system relates to an implementation of a seeker used in a moveable platform, and, more specifically, to a seeker with enhanced and dynamically adjustable detection sensitivity in a seeker with multiple linear arrays of optical detectors.

This disclosure incorporates by reference, for all purposes, U.S. Patent No. 8390802 and U.S. Patent No. 11168959.

### BACKGROUND

Seekers are typically used in various aerial munition platforms to provide guidance, navigation, and control to the munition platform during flight, especially when operating in hostile environments that may include GPS-denied environments. The seeker typically has sensors such as for visible or infrared imaging and/or radar that allows the munition platform to identify a target with precision. The seeker is typically mounted in the nose or front portion of the munition platform, or on the leading edge of one or more wings or canards, and often includes optics for focusing optical signals onto optical detectors.

Seekers are often used as part of a semiactive laser guidance system. In such a system, a laser designator, which is typically located on a designator platform such as an aircraft, ship or ground system, illuminates a target with a laser beam. This laser beam is often invisible to the naked eye and operates in the infrared spectrum. The seeker detects laser energy scattered off the target and tracks the laser energy to provide information to a navigation system or mission computer. In one embodiment, the information may note a deviation between the current pointing angle of the platform and the angle of the line of sight toward the illuminated target, enabling the mission computer to calculate necessary adjustments to the control surfaces, etc., of the platform. However, given that the energy of the scattered laser energy that is available for detection by the seeker falls with the square of the distance to the target, at long ranges it becomes difficult for the seeker to identify and track the illuminated target, as the scattered laser energy can become lost in noise from the environment. Given this, there is the need for a system to increase the sensitivity of detection of the scattered laser energy, especially when the signal-to-noise ratio of the scattered laser energy is low when compared to noise sources in the environment.

### SUMMARY

One embodiment of the present disclosure provides an optical seeker assembly in a semiactive laser guidance system, the optical seeker assembly comprising: at least three optical receivers, each optical receiver comprising: an optical waveguide configured to receive an optical signal; a bandpass optical filter having a bandwidth, wherein a laser beam wavelength is within the bandwidth, and configured to filter the optical signal; and a linear optical detector array optically coupled to the optical waveguide, the linear optical detector array comprising a plurality of pixel detectors to convert the optical signal and produce a plurality of pixel intensity signals; a first combiner configured to combine pixel intensity signals from each of pluralities of adjacent pixel detectors to produce a plurality of multipixel intensity signals; at least one first selector configured to select, from the plurality of multipixel intensity signals, the multipixel intensity signal indicating a greatest combined intensity, to produce a selected multipixel intensity signal; a second combiner configured to combine selected multipixel intensity signals from mutually adjacent optical receivers to produce a receiver pair intensity signal; a second selector to select, from a plurality of the receiver pair intensity signals, the receiver pair intensity signal indicating a greatest sum of intensities, to produce a selected receiver pair intensity signal; a comparator configured to compare the selected receiver pair intensity signal to a detection threshold value, to identify a signal detection; and a pixel location identifier configured to identify a pixel detector associated with the confirmed signal detection.

Another embodiment provides such an optical seeker assembly, further comprising a constant false alarm rate threshold setter configured to set the detection threshold value in accordance with a constant false alarm rate target.

A further embodiment provides such an optical seeker assembly, further comprising a target vector identifier configured to identify a vector to a target based on the identified pixel detector.

Yet another embodiment provides such an optical seeker assembly, wherein the constant false alarm rate threshold setter comprises a feedback circuit configured to adjust, based on a count value in a counting circuit, the detection threshold value or a threshold value from which the detection threshold value is to be calculated.

A yet further embodiment provides such an optical seeker assembly, wherein the constant false alarm rate threshold setter is configured to set the detection threshold value based on the adjusted threshold value.

Still another embodiment provides such an optical seeker assembly, wherein the constant false alarm rate threshold setter is configured to set the detection threshold value based on a standard deviation that is calculated based on digitized samples of the pixel intensity signal, multipixel intensity signal, selected multipixel intensity signal, receiver pair intensity signal, or selected receiver pair intensity signal.

A still further embodiment provides such an optical seeker assembly further comprising a correlator configured to test correlation of the signal detections, produced at respectively different times, to identify as a confirmed signal detection a signal detection that satisfies a predetermined correlation condition.

Even another embodiment provides such an optical seeker assembly, wherein the predetermined correlation condition is that of a predetermined number of signal detections have been produced during a prescribed time window, prior to a reference signal detection, at times that are at integer multiples of a period of repetition of a laser designator.

An even further embodiment provides such an optical seeker assembly, further comprising a signal-to-noise ratio calculator for calculating a signal-to-noise ratio based on the intensity of the selected multipixel intensity signal and the detection threshold value or a value from which the detection threshold value is calculated; wherein the length of the prescribed time window is determined by the signal-to-noise ratio, with the length of the prescribed time window being shorter for a greater signal-to-noise ratio than for a lesser signal-to-noise ratio.

A still even another embodiment provides such an optical seeker assembly, further comprising a switch to enable the identified vector to be used by a guidance system conditional upon identification of the confirmed signal detection.

A still even further embodiment provides such an optical seeker assembly, wherein the multipixel intensity signal is an intensity signal indicating the sum of the intensities for at least two adjacent pixels.

Still yet another embodiment provides a correlator system configured to identify a confirmed detection signal, comprising a correlator configured to test correlation of signal detections, produced at respectively different times, to identify as a confirmed signal detection a signal detection that satisfies a correlation condition that a predetermined number of signal detections have been produced during a prescribed time window, prior to a reference signal detection, at times that are at integer multiples of a period of repetition of a laser designator; a controller configured to control the length of the prescribed time window based on a signal-to-noise ratio, with the length of the prescribed time window being shorter for a greater signal-to-noise ratio than for a lesser signal-to-noise ratio.

A still yet further embodiment provides a correlator configured to identify a confirmed detection signal, comprising: a plurality of stages of FIFO registers, each configured to receive and store a clock signal and, and to output a signal if an earlier clock signal from a prescribed time earlier is already stored in the applicable FIFO register; and a selector to select the signal outputted from the FIFO register of a stage that is selected depending on a signal-to-noise ratio, wherein the stage of the FIFO register that outputted the selected signal is earlier for a greater signal-to-noise ratio than for a lesser signal-to-noise ratio.

Even yet another embodiment provides a computer program product including one or more non-transitory machine-readable mediums encoded with instructions that when executed by one or more processors cause a process to be carried out for confirming a detection signal for an optical seeker, the process comprising: processing optical signals with a plurality of pixel detectors formed as a linear optical detector array into a plurality of pixel intensity signals; converting the pixel intensity signals to digital signals and combining the digital signals from two or more adjacent pixel detectors into a plurality of multipixel intensity signals; selecting from the plurality of multipixel intensity signals at least one selected multipixel signal representing the multipixel intensity signals having a greatest combined intensity; combining the selected multipixel intensity signals and producing at least one receiver pair intensity signal; selecting, from the at least one receiver pair intensity signal, a selected receiver pair intensity signal; comparing the selected receiver pair intensity signal to a detection threshold value to identify a signal detection; and identifying a pixel detector associated with the signal detection.

Even yet further embodiment provides such a computer program product, further comprising setting the detection threshold value in accordance with a constant false alarm rate target.

Still even yet another embodiment provides such a computer program product, further comprising identifying a vector to a target based on the identified pixel detector.

The details of one or more implementations are set forth in the accompanying drawings and the description below. Other features will be apparent from the description and drawings, and from the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a diagrammatic view showing a platform equipped with a seeker according to an embodiment, the platform having been launched from a helicopter, traveling towards a designated target.

FIG. 2 is a diagrammatic view showing the deviation angle α between a platform pointing direction and a target vector to the designated target in an embodiment.

FIG. 3 is a diagrammatic view showing basic blocks of a functional structure for a seeker assembly, for providing a target vector to a guidance system, according to an embodiment.

FIG. 4 is a diagrammatic view showing functional elements of an optical receiver according to an embodiment.

FIG. 5 is a diagrammatic view showing an optical waveguide used in an embodiment to perform monoaxial focusing of an image of the vicinity of a target onto a linear optical detector array.

FIG. 6 is a diagrammatic view showing an enlargement of a portion of a platform and the location of optical receivers, which are components of a seeker according to an embodiment, within the platform of FIG. 1.

FIG. 7 shows a schematic diagram showing the relative orientations of four optical receivers in an embodiment.

FIG. 8 is a schematic diagram showing the arrangement of multiple individual pixel detectors in a linear optical detector array in a seeker according to an embodiment.

FIG. 9 is a block diagram showing schematically a signal analysis subsystem, of a seeker according to an embodiment, in association with an individual optical receiver.

FIG. 10 is a block diagram showing schematically a signal analysis subsystem, of a seeker according to an embodiment, that is provided for combining and processing the outputs from the plurality of signal analysis subsystems depicted in FIG. 9 .

FIG. 11 is a flowchart showing a method for detecting a designated target in a seeker according to an embodiment.

FIG. 12 is a schematic diagram of a portion of a constant false alarm rate threshold setter according to an embodiment.

FIGS. 13A, 13B, 13C and 13D are flowcharts showing respective embodiments of methods for setting a detection threshold value in accordance with a constant false alarm rate target according to an embodiment.

FIG. 14 is a schematic diagram of a temporal correlator according to an embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

This disclosure relates to an optical seeker assembly configured to identify, and provide relative location information for, a designated target in a semiactive laser guidance system, having dynamically adjustable detection sensitivity that adapts automatically to environmental conditions to conform to a prescribed CFAR (constant false alarm rate) to reduce computational overhead in identification of a designated target while increasing the SNR (signal-to-noise ratio) of the detection signal in a multiple linear array seeker. In embodiments, this optical seeker assembly is used in a precision guided munition in a semiactive laser guidance system.

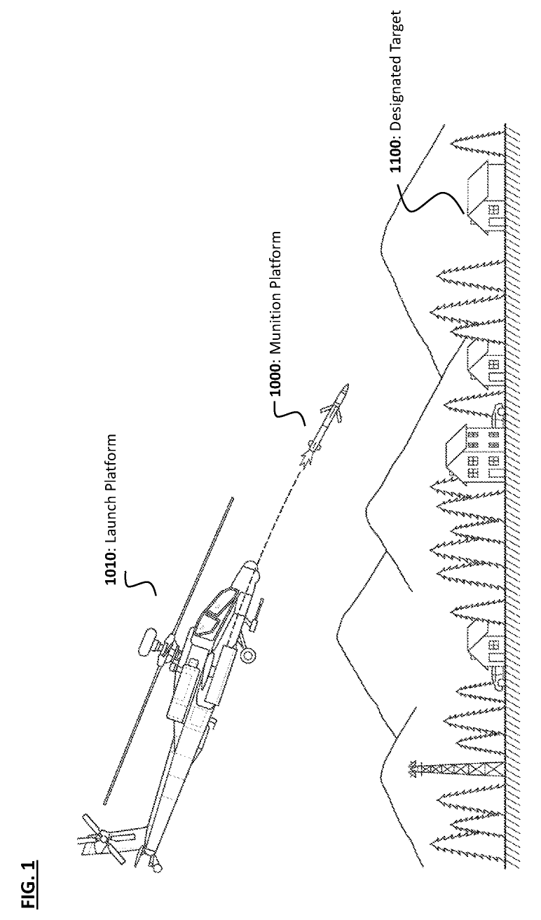

FIG. 1 depicts a possible use scenario for the optical seeker assembly of embodiments, equipped in a munition platform 1000, which, in embodiments, may be a missile, a drone, a projectile, or other precision guided munition, which may be launched from the ground, air or maritime, to assist in guidance to a designated target 1100.

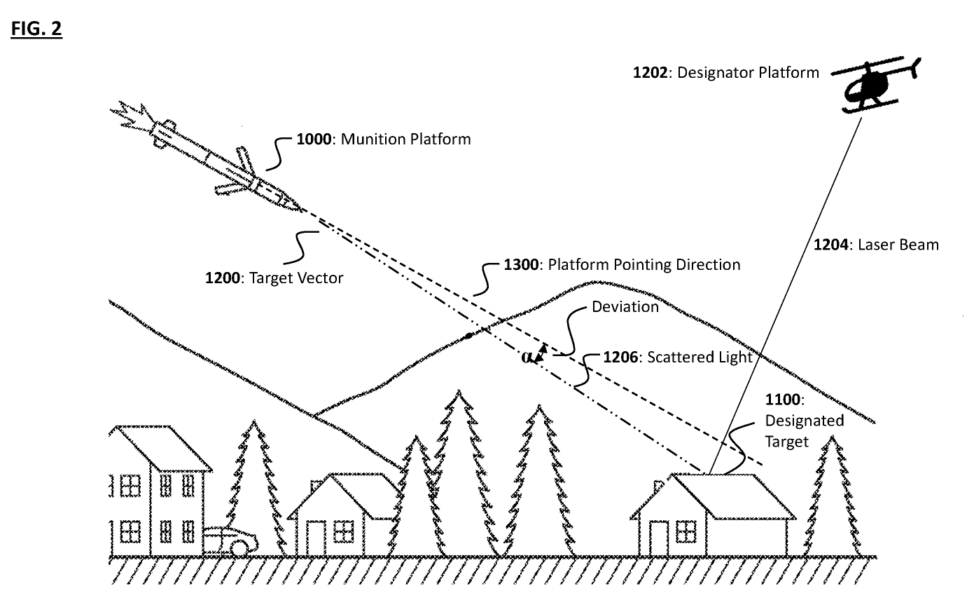

In embodiments the designated target 1100 may be stationary and located on the ground. In other embodiments, the designated target 1100 may be mobile, airborne, or seaborne. Note that in this specification, the term “designated target” refers to a target that is designated such as by a laser beam 1204 from a laser designator on a designator platform 1202, where the laser beam 1204 is directed at a target to designate, as the target, the location that is illuminated by the laser beam 1204, that is, the point from which the energy of the laser beam 1204 is scattered. Note that, as depicted in FIG. 2, in embodiments, the laser beam 1204 from the designator platform 1202 has a specific known optical frequency, which in embodiments may be in the visible range, the ultraviolet range, or the infrared range. In embodiments the laser illuminates the designated target with a known pulse frequency, where this known pulse frequency may be between 10 and 20 Hz. In embodiments, the pulse frequency may also be varied through commands or following a known pattern. In embodiments the laser illuminates the designated target with pulses of a known pulse width, where this known pulse width may be between 10 and 20 nanoseconds. Various techniques for laser designation include an external laser designator such as ground-based, at sea or air-borne.

As depicted in FIG. 2, the munition platform 1000, during travel, has a platform pointing direction 1300. However, given natural noises, such as turbulence in the air, or because of deliberate evasive routing or circuitous routing, the platform pointing direction 1300 of the platform will not necessarily be directed at the designated target 1100. Precision guidance of the platform to the designated target 1100 requires monitoring of a target vector 1200 to the designated target 1100, and monitoring of the deviation α between the platform pointing direction 1300 and the target vector 1200. In one example, a laser emitter is mounted on a designator platform 1202, which in this case is an airborne platform. The laser emitter on the designator platform 1202 emits a laser beam 1204 in the direction of a target that is to be designated as the designated target 1100. The laser beam 1204 is scattered by the designated target 1100, where some of the laser beam 1204 is scattered as scattered light 1206 toward the munition platform 1000. As noted, the laser designation can be from the ground, airborne or maritime.

In semiactive laser guidance systems of embodiments, the approach used to monitoring the target vector 1200 and the deviation α uses optical receivers, mounted on the munition platform 1000, oriented in the generally-forward direction so as to receive the laser energy that is scattered from the designated target 1100. However, as can be appreciated from an understanding of physics, the energy of the scattered light 1206, scattered by the designated target 1100 toward the munition platform 1000, falls with the distance between the munition platform 1000 and the designated target 1100, following the inverse-square law. Given this, the signal-to-noise ratio (SNR) of any signal picked up by an optical sensor falls with the square of the distance to the designated target 1100. Improving the effective operating distance of a semiactive laser guidance system requires improved SNR of the optical detection system, including improvements in SNR in the optics of the system, in the detector elements themselves, and/or in the analysis of detector data. Given this, the present disclosure teaches an optical seeker assembly, and seeker method, for a precision guided munition in a semiactive laser guidance system that provides a substantial improvement to SNR. The optical seeker assembly, and seeker method, will be explained below using embodiments depicted in the appended drawings, along with alternate embodiments that are not illustrated.

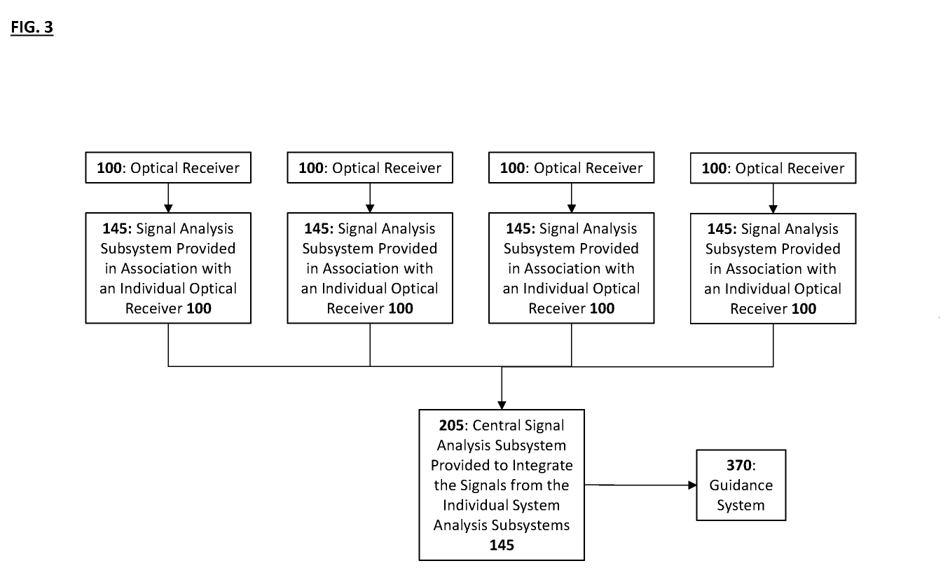

FIG. 3 is a diagrammatic view showing basic blocks of a functional structure for a seeker assembly, according to an embodiment, for providing a target vector to a guidance system. As depicted in FIG. 3, the seeker assembly comprises a plurality of optical receivers 100, typically comprising four optical receivers 100, although there is no particular limitation thereto, where some embodiments may comprise only three optical receivers 100, and other embodiments may comprise greater than four optical receivers 100. The optical receivers 100 receive the scattered light 1206 that is scattered from the designated target 1100, and the incoming optical signals are processed by the optical receivers 100 that convert the light energy into analog electrical signals that are subsequentially converted to digital signals and then analyzed and processed, as described below.

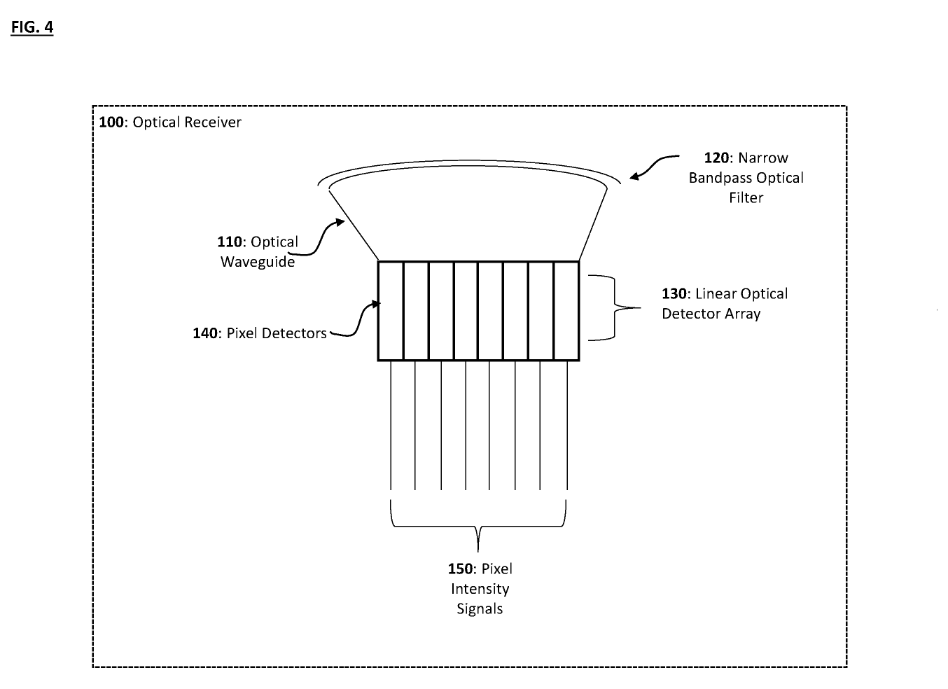

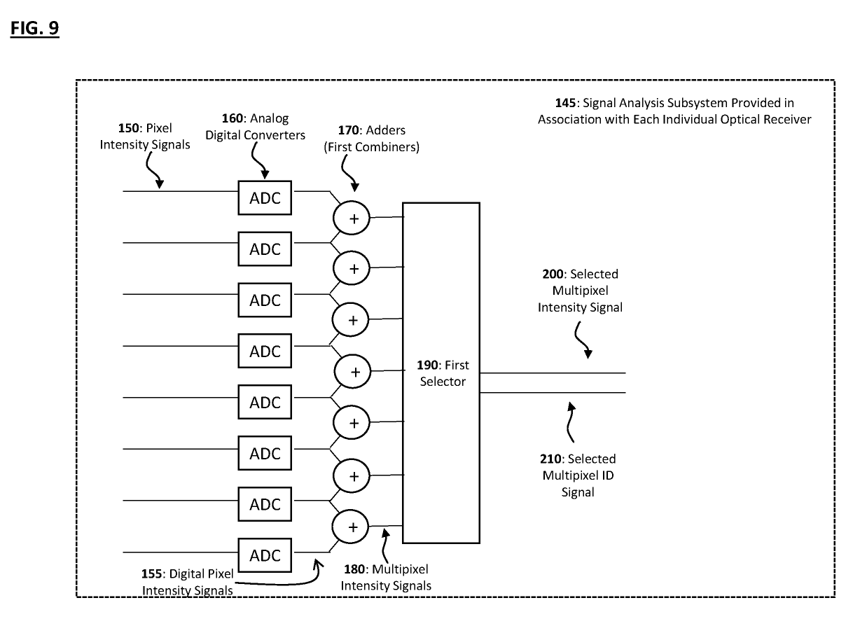

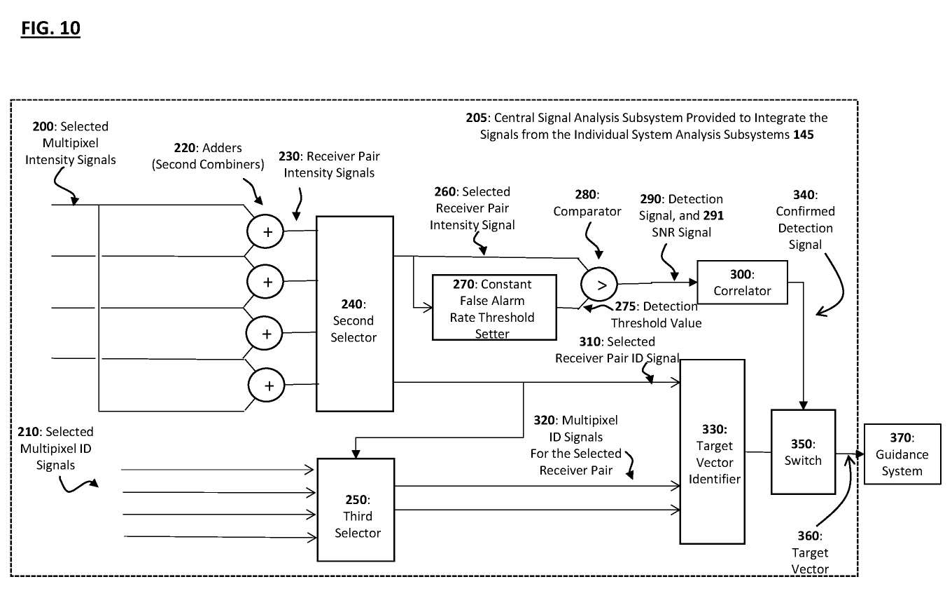

The optical receivers 100 will be explained in greater detail below, in reference to FIG. 4 through FIG. 8. In embodiments, a signal analysis subsystem 145, configured to carry out processing of pixel intensity signals 150 produced by the associated optical receiver 100, is operatively coupled to each optical receiver 100. The signal analysis subsystem 145 will be explained in greater detail in reference to FIG. 9. In embodiments, the signals produced by each of the signal analysis subsystems 145, i.e., selected multipixel intensity signals 200 and selected multipixel ID signals 210 from each signal analysis subsystem 145, as will be described below, are integrated and processed by a single central signal analysis subsystem 205, which will be described below in reference to FIG. 10, to provide a target vector 360 to a guidance system 370. The guidance system 370 will not be explained in greater detail, aside from noting that the guidance system 370 receives the target vector 360, which in embodiments may be defined as a two-dimensional deviation α from the aforementioned platform pointing direction 1300, or in other embodiments may be a vector in a global reference frame based on knowledge of the orientation of the munition platform 1000 that is provided from gyroscopic orientation detecting devices, or the like. These will not be explained in greater detail because they are not central to the current disclosure.

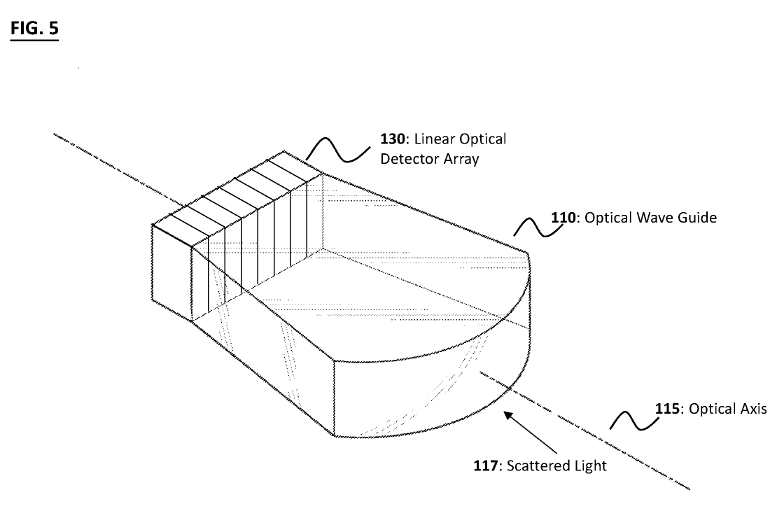

An optical receiver 100 will be explained in reference to FIG. 4 through FIG. 8. As depicted in FIG. 4, in embodiments, the optical receiver 100 comprises an optical waveguide 110, depicted in FIG. 5, a bandpass optical filter 120, and a linear optical detector array 130, which comprises a plurality of pixel detectors 140. In embodiments, the bandpass frequency of the bandpass optical filter 120 is selected to match a frequency of the energy of the laser energy scattered from the designated target 1100, depicted in FIG. 2. Note that although the bandpass optical filter 120 is depicted in FIG. 4 as being placed in front of the optical waveguide 110, there is no limitation thereto, but rather, in various embodiments, it may be a coating on the surface of the optical waveguide 110, interposed between the optical waveguide 110 and the linear optical detector array 130, or may be positioned within the optical waveguide 110, or, in other embodiments, the bandpass optical filter 120 may be achieved by the absorption/transmission of light by the material of the optical waveguide 110 itself, rather than being provided as a separate component. In one embidiment the bandpass optical filter 120 is a bandpass optical filter centered around the frequency of interest.

In embodiments, the linear optical detector array 130 is optically coupled to the optical waveguide 110. Note that while the linear optical detector array 130 is depicted in FIG. 4 as being in contact with the optical waveguide 110, there is no limitation thereto. In embodiments, the linear optical detector array 130 may instead be positioned away from the optical waveguide 110, and may be connected through optical fibers or other waveguide components, not illustrated. In embodiments, the linear optical detector array 130 comprises a single row of a plurality of individual pixel detectors 140. In embodiments the pixel detectors 140 may be of any of a variety of known optical detectors, such as photodiodes, phototransistors, photoresistors, avalanche photodiodes, or the like. In embodiments, the pixel detectors 140 are those that have been tested and selected to control uniformity of sensitivity to be within an acceptable range for the purposes of this disclosure. In embodiments, the resulting pixel intensity signals 150, described below, from the pixel detectors 140 may be in the form of voltages, electric currents, or even impedances (resulting in lower voltages or reduced currents with higher intensities of incident light); however, for ease in explanation, and with no loss of generality, the embodiments described below will assume that the pixel intensity signals 150 produced by the pixel detectors 140 are current signals, with higher currents indicating greater intensity of incident optical energy. While FIG. 4 depicts the linear optical detector array 130 as comprising eight pixel detectors 140, there is no limitation thereto, where the number of pixel detectors 140 may be set depending on the physical constraints of the installation, available room for processing hardware, required resolution, and the like. In embodiments, the linear optical detector array 130 may be configured as the “linear sensor array” described in US8390802, which is incorporated by reference herein for all purposes.

An optical waveguide 110 of embodiments is illustrated in FIG. 5. As depicted in FIG. 5, the optical waveguide 110 may be a monoaxial focusing lens, providing focusing of the scattered light 1206, from the designated target 1100, in one axial direction, onto the pixel detectors 140 in the linear optical detector array 130, while not having a focusing effect in the direction that is perpendicular thereto, although still providing an optical waveguide effect in that axial direction, thereby providing an increased field of view in the non-focusing axial direction. In embodiments, the optical waveguide 110 may be configured as the “waveguide” described in US8390802.

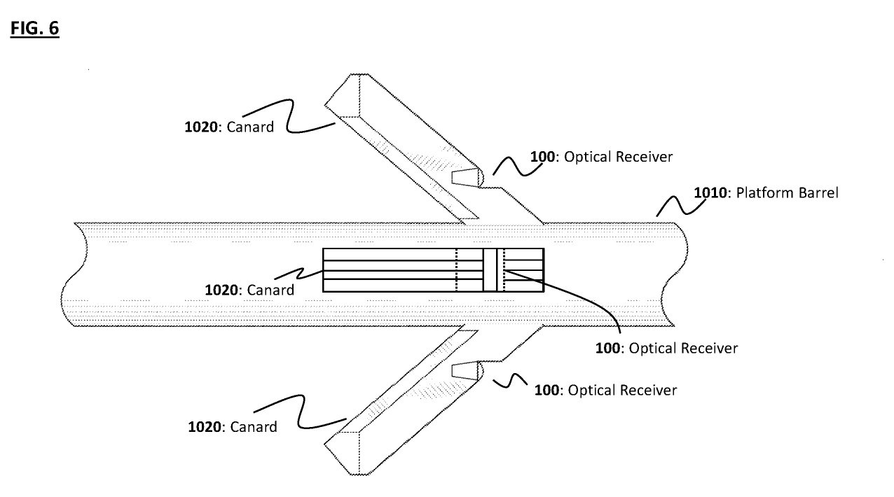

As depicted in FIG. 6, in embodiments, a plurality of optical receivers 100 is provided on the munition platform 1000, facing generally in the direction of travel of the munition platform 1000. Note that in FIG. 6 the optical receivers 100, which are disposed in canards 1020 such that the optical waveguide 110 is seen externally from the canard 1020 and the linear optical detector array 130 is internal within the canard and platform barrel 1010. The internal linear optical detector arrays 130 extend radially outwardly, are viewed from a first side in the canards 1020 that are depicted extending upward and downward in the drawing, and viewed from a second side, perpendicular to the first side, in the canard 1020 that is depicted as extending out of the plane of the paper, with the detailed structures thereof omitted for clarity in the illustration. In embodiments, the optical receivers 100 are disposed on the leading edge of canards 1020 of the munition platform 1000 that is a guided missile, where the canards 1020 are spaced at regular angular intervals around a platform barrel 1010, extending outward from the platform barrel 1010. However, there is no limitation on the number of optical receivers, and the optical receivers 100 may be disposed in multiple locations. The optical receivers 100 can extend radially outward on the canards, along the platform barrel,and/or in the nose of the munition platform 1000.

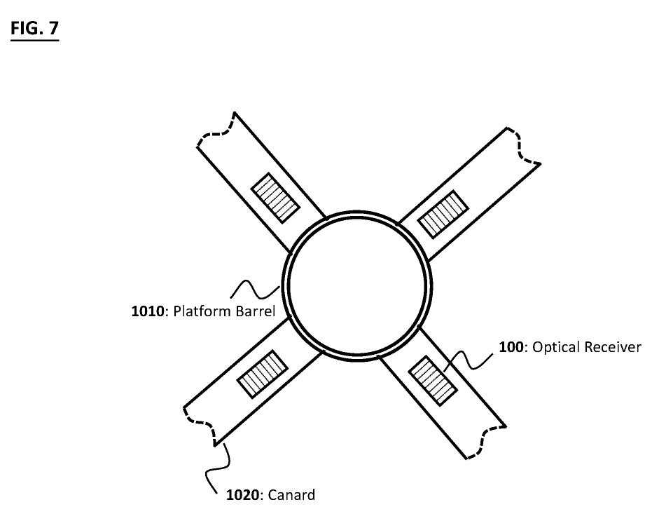

As depicted in FIG. 7, in embodiments, the optical receivers 100 are disposed in multiple locations so as to extend outwardly in directions that can form a plane that is perpendicular to the direction of travel of the munition platform 1000, this direction of travel, in FIG. 7. being out of the plane of the paper. That is, if the direction of travel of the munition platform 1000 is defined as the Z-axial direction, the plurality of optical receivers 100 extend in directions that have X- and Y-axial components, so as to be able to provide two-dimensional data. Note that in FIG. 7, the optical receivers 100 are viewed from the front (the direction that is facing the designated target 1100). In this view, only the details of the linear optical detector array 130 are shown through the optical wave guide 110. While in FIG. 7 the optical receivers 100 are depicted as extending in two mutually orthogonal directions, there is no limitation thereto, insofar as the optical receivers 100 are not all parallel to each other.

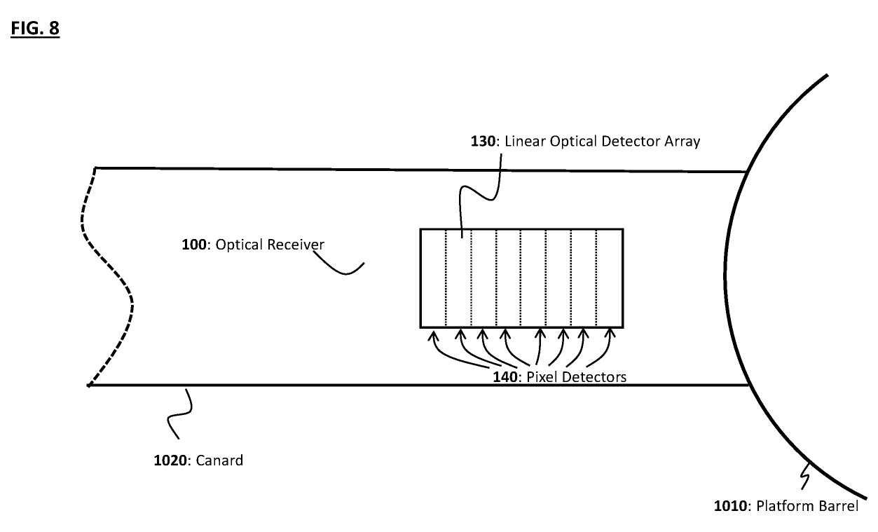

FIG. 8 depicts the arrangement of the individual pixel detectors 140, within a linear optical detector array 130 according to an embodiment, in relation to the canard 1020 and the platform barrel 1010 of a munition platform 1000, indicating that the individual pixel detectors 140 are arranged linearly extending outwardly from the axis of the munition platform 1000. Note that, as was the case in FIGS. 7, in 8, the optical receiver 100 is viewed from the front, in which view only the details of the linear optical detector array 130 are shown through the optical wave guide 110, where, in this view, the outline of the optical receiver 100 is defined by the outline of the optical waveguide 110. In embodiments, each individual pixel detector 140, depicted in FIGS. 4 and 8, performs photovoltaic conversion of an optical signal impinging thereon through the optical waveguide 110, generating an electric signal that is indicative of the intensity of the light signal of the frequency of light that passes through the bandpass optical filter 120 to impinge on the given pixel detector 140. Given this, in the presence of a spot of laser light that is designating a designated target 1001 that is within the field of view of the optical receiver 100, in embodiments that spot will be focused, by the optical waveguide 110, depicted in FIG. 5, onto one or more pixel detectors 140 of the linear optical detector array 130 depending on the angle of deviation α between the optical axis 115 of the optical waveguide 110, depicted in FIG. 5, and the target vector 1200 to the spot where the laser light is being scattered. In embodiments, a pixel intensity signal 150 will be produced by each pixel detector 140 (either through background noise or through the scattered laser energy impinging on the pixel detector 140), and if the scattered laser energy impinging on the given pixel detector 140 (or on a combination of pixel detectors 140) is greater than the background noise signal, the location in the external environment from which the laser energy is scattered can be ascertained through identifying the strongest pixel intensity signal 150 (or combination of pixel intensity signals 150) and identifying a pixel detector 140 that is associated therewith, together with information that associates the individual pixel detectors 140 with specific angles, relative to the optical axis 115 depicted in FIG. 5, of incidence of light that impinges on the respective pixel detectors 140. In embodiments, the use of two optical receivers 100, disposed so as to not be parallel to each other, enables the location of the origin of the scattered laser energy in the external environment to be ascertained in two dimensions.

It should be noted, however, that, in embodiments, the image of the spot on the designated target 1100 that is illuminated by the designating laser beam, projected from the external environment onto the linear optical detector array 130 through the optical waveguide 110, is not infinitesimally small, and in embodiments the image of the spot on the designated target 1100 may be defocused deliberately, in the direction in which the linear optical detector array 130 extends, and thus may bridge two or more pixel detectors 140, producing increased intensity in two or more pixel detectors 140 in a given linear optical detector array 130, where these intensities are indicated by the respective pixel intensity signals 150. Note that the use environment of the optical seeker assembly inherently will have optical noise, and thus in embodiments pixel intensity signals 150 will be produced from all pixel detectors 140, regardless of whether or not scattered laser light is incident thereon.

In embodiments, the signal analysis subsystem 145 and central signal analysis subsystem 205 of embodiments provide an enhanced ability to discriminate between the signal and the noise that are described in the preceding paragraph. The signal analysis subsystem 145 that is provided in association with each individual optical receiver 100 will be explained in reference to FIG. 9. In embodiments, the pixel intensity signal 150, produced by a given optical receiver 100, is received by the signal analysis subsystem 145 that is associated with that optical receiver 100. Specifically, in embodiments, each optical receiver 100 is operatively coupled to a corresponding signal analysis subsystem 145, where the pixel intensity signals 150 from the optical receiver 100 are subjected to analog-to-digital (A/D) conversion through respective A/D converters 160. Note that prior to this A/D conversion, in embodiments, the pixel intensity signals may be subjected to other signal conditioning treatments, not shown, such as conversion from a current signal to a voltage signal through a transimpedance amplifier, correction for background level, saturation monitoring and remediation, amplification/attenuation, blocking remediation, high-pass filtering, and so forth. In embodiments, each pixel intensity signal 150, from the respective pixel detector 140, is converted by the respective A/D converter 160, to produce a digital pixel intensity signal 155. In embodiments, the A/D converter 160 may operate at 100 MHz. The digital pixel intensity signals 155 are applied to adders (first combiners) 170, as depicted in FIG. 9, to add together the intensities of the pixel intensity signals 155 deriving from adjacent pixel detectors 140, thereby producing multipixel intensity signals 180. This makes it possible to sum together the intensities deriving from an illuminated spot that is projected onto the linear optical detector array 130 spanning adjacent pixel detectors 140, making it possible to identify and locate the full energy of the scattered laser energy of that spot, thereby increasing the signal-to-noise ratio when compared to a scenario wherein only a portion of the energy is measured using a single pixel detector 140. Note that while in the embodiment that is illustrated the adders 170 add the digital pixel intensity signals deriving from two pixel detectors 140, there is no limitation thereto, but rather in other embodiments the configuration may be such that each adder adds together the digital pixel intensity signals 155 deriving from three or more adjacent pixel detectors 140. This enables capturing of the full incident laser energy in scenarios where the focusing by the optical waveguide 110 spans more than two pixels.

Note that in the illustrated embodiment, the multipixel intensity signals 180 are pixel pair intensity signals. In embodiments, these multipixel intensity signals 180 that are produced by the adders 170 are applied to a first selector 190. In embodiments, the first selector 190 is configured to select, and pass therethrough, the multipixel intensity signal 180 of the greatest intensity among all of the multipixel intensity signals 180 that are applied thereto. In embodiments, the first selector 190 is also configured to identify the input terminal into which this maximum multipixel intensity signal 180 is inputted, thereby identifying (indirectly) the pair of pixel detectors 140 from which the maximum multipixel intensity signal 180 derived. In embodiments, the first selector 190 thus outputs a selected multipixel intensity signal 200 that is equal to the maximum multipixel intensity signal 180 that was inputted, and also outputs a selected multipixel ID signal 210, indirectly indicating the pixel detectors 140 that are the origins of the maximum multipixel intensity signal 180.

Note that while in the embodiment set forth above the A/D converters 160 were provided for each pixel intensity signal 150, to perform A/D conversion prior to adding by digital adders 170 and selecting selector 190, there is no limitation to this sequence; in other embodiments the adding and selecting may be performed in the analog domain using analog adders 170 and an analog selector 190, or may be performed through an arbitrary combination of analog and digital processing. Accordingly, in embodiments the digital pixel intensity signal 155 may be omitted, and the multipixel intensity signal 180 and selected multipixel intensity signal 200 may be analog or digital.

In embodiments, a signal analysis subsystem 145, as set forth above, is operatively coupled to each optical receiver 100. In embodiments the signal analysis subsystem 145 may be collocated and integrated with the applicable optical receiver 100, while in other embodiments all of the signal analysis subsystems 145 may be located together, integrated into a single circuit board or a single chip. In other embodiments, a single signal analysis subsystem 145 may be provided, and shared through temporal multiplexing/time sharing, providing virtual signal analysis subsystems 145 to each of the optical receivers 100. Conversely, in other embodiments dedicated A/D converters 160 may be provided for each optical receiver 100, with only the adders 170 and first selector 190 shared, through temporal multiplexing/time sharing, by multiple optical receivers 100. Regardless of the physical structuring of the signal analysis subsystems 145, in embodiments a combination of a selected multipixel intensity signal 200 and a selected multipixel ID signal 210 is produced for each optical receiver 100. Note that, in embodiments, these signals 200 and 210 may be produced continuously, or, in other embodiments, may be produced at prescribed sampling intervals.

In embodiments, the selected multipixel intensity signals 200 and selected multipixel ID signals 210, produced for each of the optical receivers 100, are received by the central signal analysis subsystem 205, depicted in FIG. 10. In embodiments, as depicted in FIG. 10, a selected multipixel intensity signal 210 for each optical receiver 100, produced by the respective signal analysis subsystem 145, is applied to adders 220 (second combiners). In embodiments, these adders 220 have a function that is analogous to that of the adders 170, described above, adding together the selected multipixel intensity signals of adjacent optical receivers 100, to produce receiver pair intensity signals 230. Note that while, in embodiments, the number of adders 170 in the signal analysis subsystem 145 is one fewer than the number of digital pixel intensity signals 155 applied thereto (given that the number of boundaries between adjacent pixel detectors 140 is one fewer than the number of pixel detectors 140), in embodiments the number of adders 220 in the central signal analysis subsystem 205 is equal to the number of selected multipixel intensity signals 200. This is because the optical receivers 100 are disposed at approximately equal angular intervals around the platform barrel 1010, in embodiments, or otherwise at equal angular intervals around the axis that is the platform pointing direction 1300 in FIG. 2, meaning that adjacency relationships between the optical receivers 100 are cyclical. In embodiments, the adders 220 produce receiver pair intensity signals that indicate the sum of the intensities of the respective selected multipixel intensity signals 200 that are applied thereto.

In embodiments, the receiver pair intensity signals 230 are applied to a second selector 240, which is configured similarly to the first selector 190, set forth above, in the signal analysis subsystem 145. The second selector 240 thus, in embodiments, outputs a selected receiver pair intensity signal 260 that indicates the intensity of the maximum receiver pair intensity signal 230 that is applied thereto. In embodiments, the second selector 240 also outputs a selected receiver pair ID signal 310, based on the input terminal (not shown) of the second selector 240 to which the maximum receiver pair intensity signal 230 was applied, thereby identifying, indirectly, the pair of optical receivers 100 that was the origin of the maximum receiver pair intensity signal 230. In embodiments, the adders 220 and the second selector 240 enable summing of scattered laser energy received by two optical receivers 100, further increasing the signal-to-noise ratio of the signal produced at this point. Note that in many practical applications, if four optical receivers 100 are disposed in canards 1020, as depicted in FIG. 6, for example, two of the optical receivers 100 may be in the shadow of the platform barrel 1010 or may be at angles where no scattered laser energy is detected, so that not all of the optical receivers 100 will produce a signal in response to the scattered laser energy. Thus this configuration where the selected outputs of adjacent optical receivers 100 are added together and the maximum result is selected both improves the signal-to-noise ratio, and identifies the optical receivers that are positioned to receive a signal from the designated target 1100. Even in cases where three or four of the optical receivers 100 produce signals in response to scattered laser energy, adding together the outputs of adjacent pairs of optical receivers 100, and selecting the pair with the maximum result, improves the signal-to-noise ratio without requiring the greater circuit complexity that would be needed to identify signal versus noise for a greater number of optical receivers 100. Thus in embodiments the maximum signal obtained by adding the signals from only adjacent pairs of optical receivers 100 is selected and used.

In embodiments, the selected receiver pair ID signal 310 is applied to a third selector 250. This third selector 250 is not configured in the same manner as the first selector 190 and the second selector 240, described above. Rather than selecting the maximum signal inputted thereto, as was the case for the first selector 190 and the second selector 240, in embodiments the third selector 250 is configured to input, as a control signal, the selected receiver pair ID signal 310, to select, based thereon, from among the selected multipixel ID signals 210 that are applied thereto, the selected multipixel ID signals 210 that derive from the pair of optical receivers 100 that produced the maximum receiver pair intensity signal 230 that was selected by the second selector 240, to thereby produce two multipixel ID signals 320 for the selected receiver pair. The combination of the multipixel ID signals 320 for the selected receiver pair, together with the selected receiver pair ID signal 310, enables identification of all of the pixel detectors 140 that contributed to the selected receiver pair intensity signal 260. In embodiments, the selected receiver pair ID signal 310 and the two multipixel ID signals 320 for the selected receiver pair may be combined into, for example, a single eight-bit ID signal (two bits to identify the selected pair of optical receivers 100, and three bits each to identify the pairs of pixel detectors 140 therein).

In embodiments, the selected receiver pair ID signal 310 and the multipixel ID signals 320 for the selected receiver pair, or the eight-bit ID signal derived therefrom, may be applied to a correlator 300, for use in a correlation process, described below. The selected receiver pair ID signal 310 and the multipixel ID signals 320 for the selected receiver pair are applied to a target vector identifier 330. In embodiments, the target vector identifier 330 references two lookup tables, not shown, to identify an azimuth angle and an elevation angle, which together combine to be a target vector 360, having a deviation of α from the platform pointing direction 1300, explained in reference to FIG. 2, based on the specific pixel detectors 140 in the specific optical receivers 100 that are associated with the combination of multipixel ID signals 320 and selected receiver pair ID signals 310. In other embodiments, the target vector identifier 330 references two lookup tables, not shown, to identify an azimuth angle and an elevation angle, which together combine to be a target vector 360, having a deviation of α from the platform pointing direction 1300, explained in reference to FIG. 2, based on a centroid calculated based on the outputs of all pixel detectors 140 for each of the specific optical receivers 100 that are associated with the selected receiver pair ID signals 310, where, in embodiments, each centroid is calculated and used in lookup tables through a technique such as described in United States Patent 8390802, which is incorporated by reference herein for all purposes. While in embodiments the multipixel ID signals 320 may take a variety of forms, in embodiments they may be single-byte numbers from 1 through 7, numbering the pixel detectors 140 sequentially, from the nearest to the axis of the munition platform 1000 to the furthest from the axis of the munition platform 1000, indicating, as a reference, the pixel detector 140, of the relevant pair, that has the lowest pixel detector number. For example, in embodiments a multipixel ID signal 320 of “2” may indicate the second and third pixel detector 140 in the applicable optical receiver 100. In embodiments the selected receiver pair ID signal 310 may indicate the number of the applicable optical receiver 100, when counting in a clockwise direction, for example, from a reference optical receiver 100. For example, in embodiments a selected receiver pair ID signal 310 of “1” may indicate the optical receiver 100 that is immediately clockwise from the reference optical receiver 100, along with the optical receiver 100 that is adjacent clockwise thereto. In embodiments, a selected receiver pair ID signal 310 of “3” may indicate the optical receiver 100 that is the third optical receiver 100 when counting clockwise from the reference optical receiver 100, along with the optical receiver 100 that is adjacent clockwise thereto, which, in a system that comprises a total of four optical receivers 100, would be the reference optical receiver 100 itself. Thus in embodiments the pixel detectors 140 from which the selected receiver pair intensity signal 260 derived can be ascertained unambiguously. In embodiments the target vector identifier 330 comprises a lookup table, which, in embodiments, is derived empirically through testing, or in other embodiments is derived through design or simulation, whereby the deviation angle α between the target vector 360 and the platform pointing direction 1300, in reference to a reference frame defined in relation to the reference optical receiver 100, can be identified unambiguously. In other embodiments, a mathematical transformation is performed using a known technique to convert from the deviation angle α, in a reference frame that is based on the reference optical receiver 100, to a global reference frame, using other information (a gravitational vector, gyroscopic orientation tracking, or the like) that indicates the orientation of the munition platform 1000.

Returning again to FIG. 10, in embodiments associated with FIG. 10, the selected receiver pair intensity signal 260 is applied to a constant false alarm rate (CFAR) threshold setter 270, described in detail below, to serve as the basis for deriving a detection threshold value 275, which is provided to a comparator 280. In embodiments, the comparator 280 is configured to generate a detection signal 290 if the selected receiver pair intensity signal 260 is greater than the detection threshold value 275, described in greater detail below. It should be noted that this detection signal 290 does not necessarily indicate that scattered light from the designated target 1100 has been detected. Rather, as described below, the detection threshold value 275 that is applied to the comparator 280 is set to a value that causes a prescribed constant false alarm rate. In embodiments, the number of “false alarms,” that is, the number of detection signals that are generated without actually detecting laser energy scattered from the designated target 1100, may be much larger than the number of confirmed detections, described below. In embodiments, the number of detection signals may be an order of magnitude or more greater than the number of detection signals that are ultimately confirmed, as “confirmed detection signals” to have derived from laser energy scattered from the designated target 1100.

Note that in embodiments the detection signal 290 may be a binary signal, with one value indicating a confirmed detection and the other value indicating non-detection. That is, in embodiments a selected receiver pair intensity signal 260, when applied to the comparator 280, will produce one binary value for the detection signal 290 if the selected receiver pair intensity signal 260 is greater than the detection threshold value 275, and the other binary value if the selected receiver pair intensity signal 260 is less than the detection threshold value 275. In embodiments, the comparator 280 is configured to also generate an SNR signal 291 that indicates a ratio of the selected receiver pair intensity signal 260 to the detection threshold value 275, thus acting as a single-to-noise ratio calculator. In embodiments, this SNR signal is applied to the correlator 300, to control the functioning of the correlator 300, as described below.

In embodiments, the detection signal 290 from the comparator 280 is applied to a correlator 300, described below, that is configured to carry out a correlation process with detection signals 290 that have been received in the past, to thereby confirm whether or not the detection signal derives from laser energy scattered from the designated target 1100.

In embodiments, upon confirmation of correlation in the correlator 300 to confirm the detection signal 290 as a confirmed detection signal 340, the confirmed detection signal 340 causes a switch 350 to relay the target vector 360 to a guidance system 370. In other embodiments, the target vector 360 is always applied to the guidance system 370, and the confirmed detection signal 340 signals the guidance system 370 that the target vector 360 is validated for use in guiding the munition platform 1000. In embodiments, the guidance system 370 uses the target vector 360 as the basis for generating control signals to control the control surfaces of the munition platform 1000 or otherwise control the path followed by the munition platform 1000.

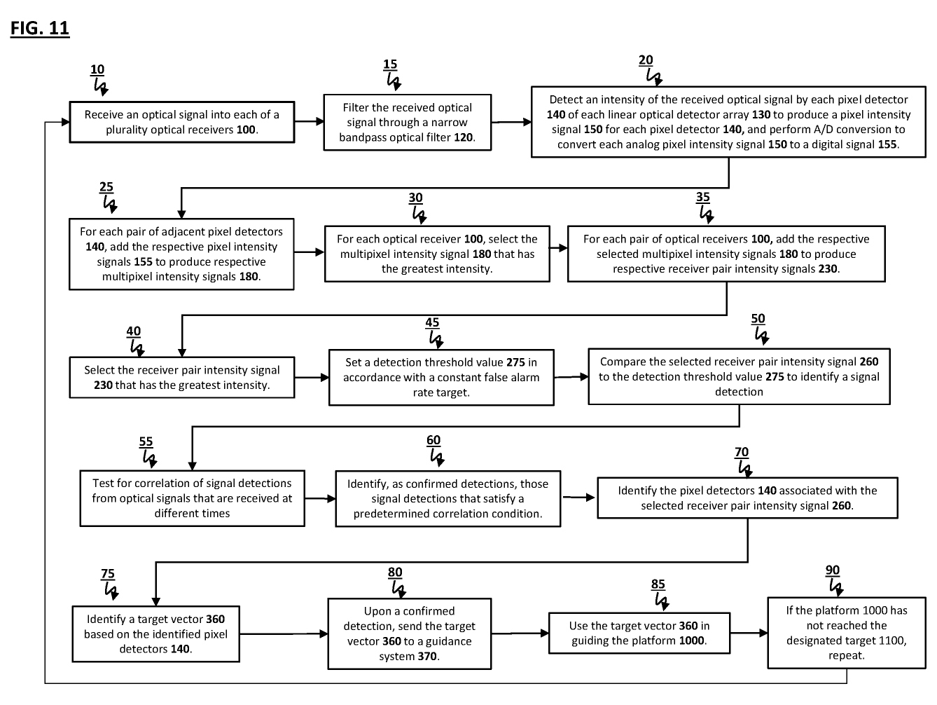

Prior to describing specific embodiments of the constant false alarm rate threshold setter 270 and the correlator 300, an embodiment of a seeker method will be explained in reference to FIG. 11.

As depicted in FIG. 11, an optical signal is received 10 into each of the plurality of optical receivers 100. Note that in embodiments the optical signal that is received only rarely includes light, from a designator laser, that is scattered from the designated target 1100. This is because typically a designator laser produces a pulsed laser emission, with, for example, a pulse width of 10 ns and a pulse frequency of between 10 and 20 Hz. Thus laser energy will be scattered from the designated target 1100 for no more than 200 ns out of every second, approximately 1/5000000 of the time. Thus, in embodiments, the “optical signal” received by the plurality of optical receivers 100 will nearly always consist entirely of noise. This makes it possible, when characterizing, in embodiments, the noise in the “optical signal,” to ignore the rare occasions wherein an actual scattered signal is received.

In embodiments, the received optical signal is filtered 15 through a bandpass optical filter 120, to attenuate frequencies of light that will not appear in the signal of interest that is scattered from the designated target 1100. The received optical signal is focused, by the optical waveguide 110, onto the pixel detectors 140. In embodiments this focusing may be performed prior to the filtering 15, while in other embodiments this focusing may be performed after the filtering 15, and in other embodiments may be performed during the filtering 15.

The intensity of the optical signal received by each pixel detector 140 of each linear optical detector array 130 is detected 20 to produce a pixel intensity signal 150 for each pixel detector 140. In embodiments this detection 20 may be carried out through photovoltaic conversion. Conversely, as described above, in embodiments, the optical detection 20 may be through any of a variety of known optical detection techniques, but for ease in explanation, and with no loss of generality, the embodiments described below will assume that the pixel intensity signals 150 produced by the pixel detectors 140 are voltage signals, with higher voltages indicating greater intensity of incident optical energy. After necessary signal conditioning to protect from blocking signals, to adjust amplification or attenuation rates, etc., in embodiments analog/digital conversion is carried out to convert each analog pixel intensity signal 150 to a digital pixel intensity signal 155.

For each pair of adjacent pixel detectors 140, in embodiments the respective digital pixel intensity signals 155 are combined (added together) 25, to produce respective multipixel intensity signals 180, which indicate the total energy received by the pair of adjacent pixel detectors 140. Note that in embodiments this adding 25 may be carried out in analog instead, prior to A/D conversion.

For each optical receiver 100, in embodiments the multipixel intensity signal 180 that has the greatest intensity is selected 30 by the first selector 190 to produce a selected multipixel intensity signal 200. In embodiments, the first selector 190 also identifies, from the terminal thereof to which the maximum multipixel intensity signal 180 was applied, a selected multipixel ID signal 210 that identifies the pixel detectors 140 that were the origin of the selected multipixel intensity signal 200.

In embodiments, the processes set forth above are carried out in relation to each of the optical receivers 100 in the optical seeker assembly. In embodiments, these processes for different optical receivers 100 may be carried out substantially simultaneously through hardware that is dedicated exclusively to the specific optical receiver 100, or may be carried sequentially out using shared hardware resources through timesharing (temporal multiplexing).

In embodiments, for each pair of optical receivers 100, the respective selected multipixel intensity signals 180 are combined (added together) 35 to produce respective receiver pair intensity signals 230.

In embodiments, the receiver pair intensity signal 230 that has the greatest intensity is selected 40 by a second selector 240 to produce a selected receiver pair intensity signal 260. In the same manner as in 30, above, in embodiments the optical receivers 100 that produced the selected receiver pair intensity signal 260 are identified by the second selector 240, based on the terminal thereof into which the maximum receiver pair intensity signal 230 was inputted, to thereby produce a selected receiver pair ID signal 310.

In embodiments, a detection threshold value 275 is set 45 in accordance with a constant false alarm rate target. This setting 45 may be achieved through a variety of methods, explained in detail below. Note that, depending on the method used, in embodiments this step may be done at any time, in parallel to any of the other processes described above.

In embodiments, the selected receiver pair intensity signal 260 is compared 50 to the detection threshold value 275 to identify a signal detection. Note that here “signal detection” does not imply that that which is detected is an actual signal that includes laser energy that is scattered from the designated target 1100, but because such scattered laser energy is only rarely detected, in embodiments the “signal detection” nearly always refers merely to detecting a noise signal that rises above the detection threshold value 275. In embodiments, this comparing 50 may also produce an SNR signal that indicates a ratio of the selected receiver pair intensity signal 260 to the detection threshold value 275, which, in embodiments, may be provided to the correlator 300, to control the correlation testing 55 therein.

In embodiments, signal detections are tested 55 for correlation with signals that have been received in the past, to thereby identify 60, as confirmed detections, those signal detections that satisfy a predetermined correlation condition. This testing 55 and identification 60 will be described in greater detail below. In embodiments this testing 55 and identification 60 may use the multipixel ID signals 320 and the selected receiver pair ID signal 310.

In embodiments, the pixel detectors 140 associated with the selected receiver pair intensity signal 260 are identified 70. In embodiments, this is achieved based on the selected receiver pair ID signal 310 in combination with the multipixel ID signals 320, produced above.

In embodiments, a target vector 360 is identified 75 based on the identified pixel detectors 140. In embodiments, this is achieved by using a lookup table, to produce a deviation α between a platform pointing direction 1300 and a target vector 1200 in the platform frame, with respect to a reference optical receiver 100, and in embodiments this is translated, through a matrix calculation, or the like, to a global frame, based on knowledge of the actual orientation of the munition platform 1000.

In embodiments, upon a confirmed detection, the target vector 360 is sent 80 to a guidance system 370 by switching a switch. Conversely, in other embodiments the target vector 360 is sent to the guidance system 370, and, upon a confirmed detection, a signal is sent to the guidance system 370 indicating that the target vector 360 is valid, and can be used reliably for precision guidance.

In embodiments, the target vector 360 is used 85 in guiding the munition platform 1000 toward the designated target 1100, through controlling, for example, control surfaces of the munition platform 1000.

If the munition platform 1000 has not reached the designated target 1100 or travel thereof has not otherwise been terminated, in embodiments the steps set forth above are repeated 90 from receiving 10 the optical signal.

In embodiments, most of the steps set forth above are performed continuously; however, depending on embodiments, continuous processing is not possible for some of the steps set forth above. For example, as will be explained in greater detail below, the detection setting 45 and the testing 55 and identification 60, described above, cannot be performed continuously in some envisioned embodiments. In embodiments, these processes may be performed at sampling rates of, for example, 10 MHz.

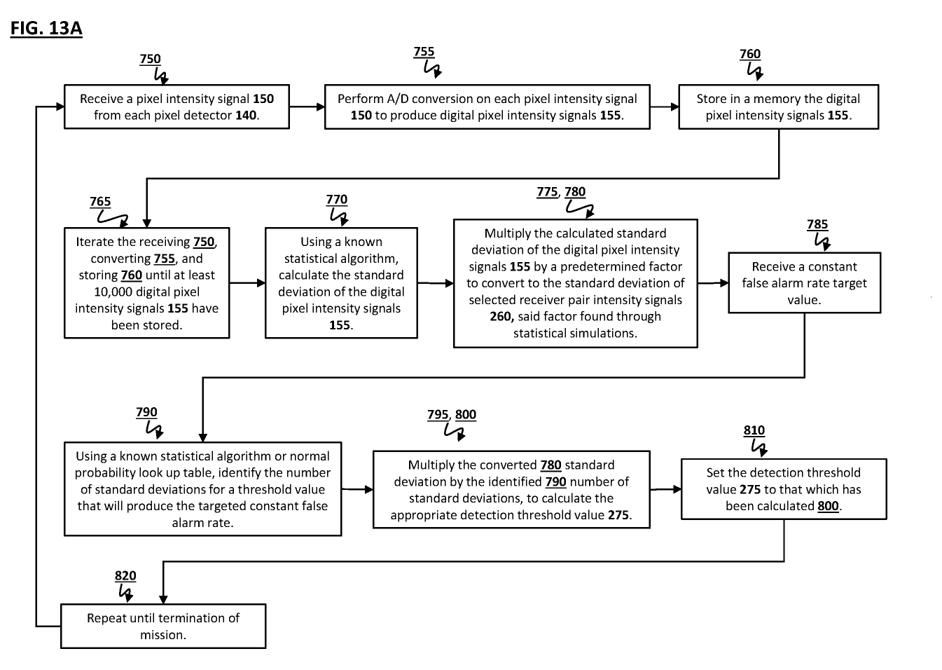

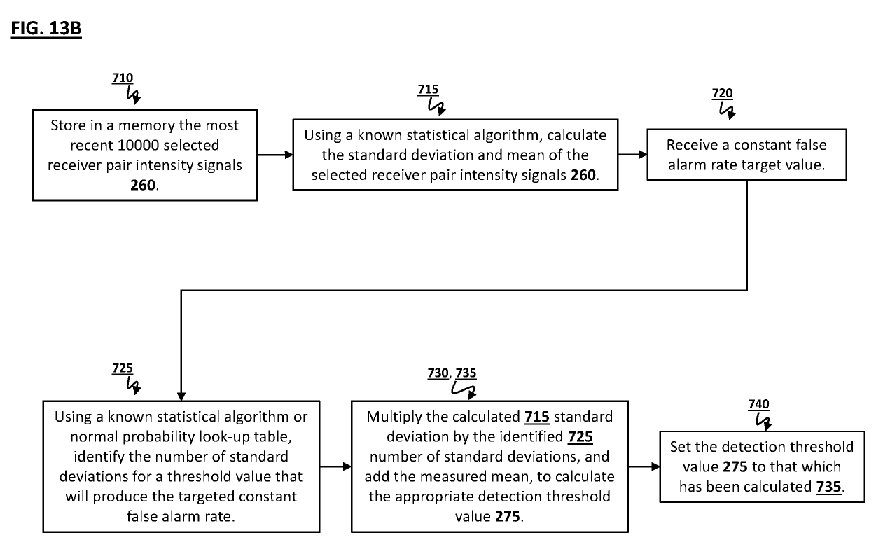

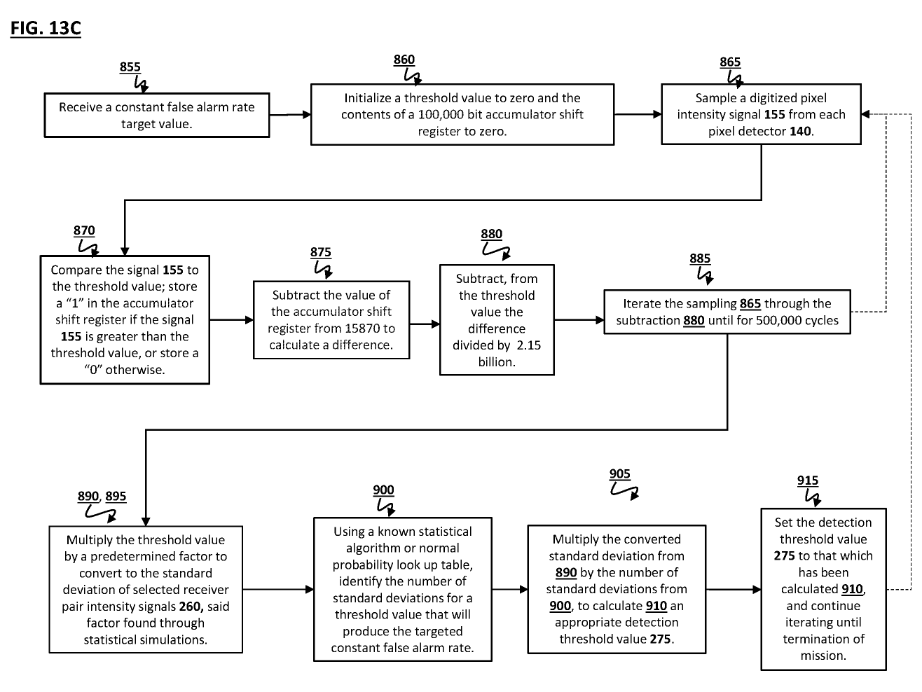

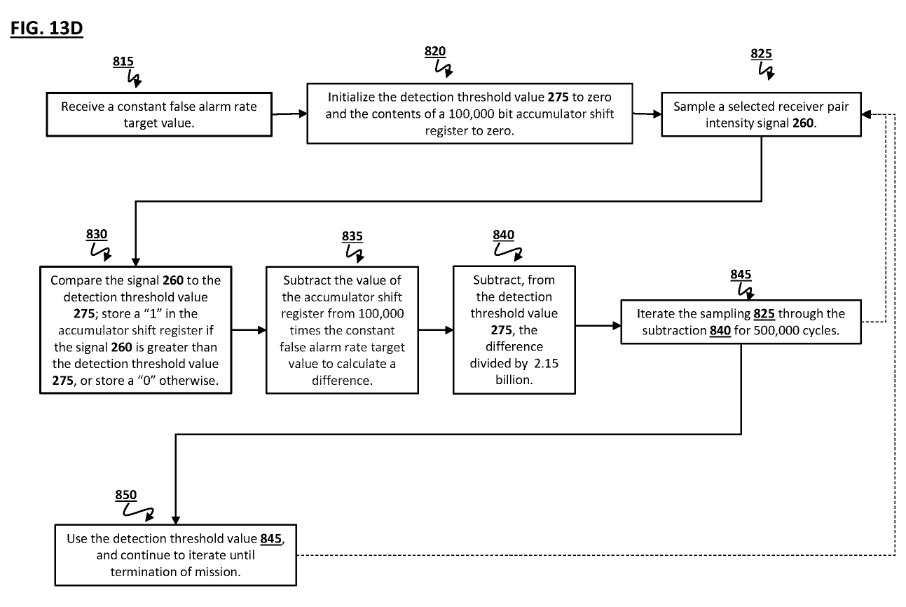

The flowcharts of FIG. 13A through FIG. 13D will be used next to explain various methods for setting the detection threshold value 275 in various envisioned embodiments, however, it is to be understood that possible methods for setting the detection threshold value 275 are not limited thereto.

Starting with FIG. 13A, in embodiments, a pixel intensity signal 150 is received 750 from each individual pixel detector 140. In embodiments, analog-digital conversion is performed 755 on each pixel intensity signal 150 to produce digital pixel intensity signals 155 (digitized samples), followed by conditioning of the signals through, for example, high-pass filtering, protection against blocking, and the like. Because, in embodiments, the receiving 750 of signals and the conversion 755 are also performed as part of the seeker method that was described above in reference to FIG. 11, there is no need for additional hardware or processing overhead to perform these steps.

In embodiments, the digital pixel intensity signals 155 are sampled at a rate of, for example, 100 MHz, and stored 760 in a memory. In embodiments, this process of receiving 750, converting 755, and storing 760 is iterated 765, until at least 10,000 digital pixel intensity signals 155 have been stored 760. The standard deviation of the digital pixel intensity signals 155 that have been stored 760 is then calculated 770 using a known statistical algorithm. Following this, the calculated 770 standard deviation of the digital pixel intensity signals 155 is multiplied 775 by a predetermined factor to convert 780 to an estimated standard deviation of the selected receiver pair intensity signals 260. In embodiments this factor may be determined in advance through statistical calculations, through actual measurements on test assemblies, or through statistical simulations. The result of specific simulation of the relationship between the standard deviation of the digital pixel intensity signals 155 and the selected receiver pair intensity signals 260 in the configuration depicted in FIG. 9 and FIG. 10 using the method that was described in reference to FIG. 11 is that, in the embodiment that is illustrated is that, in embodiments, 1.213 is an appropriate factor to calculate the standard deviation of the selected receiver pair intensity signals 260 from the digital pixel intensity signals 155.

A constant false alarm rate target value is received 785. In embodiments, this reception 785 may be performed prior to, during, or after the other steps set forth above. Using a known statistical algorithm or normal probability lookup table, in embodiments the number of standard deviations for a threshold value to produce the targeted constant false alarm rate is identified 790, and the converted 780 standard deviation is multiplied 795 by the identified 790 number of standard deviations, to thereby calculate 800 an appropriate detection threshold value 275, which is then set 810 in the comparator 280.

If the munition platform 1000 has not reached the designated target 1100 or travel thereof has not otherwise been terminated, in embodiments the procedures set forth above are repeated 810 from receiving 750 the pixel intensity signal.

In embodiments wherein no high-pass filter is applied to the selected receiver pair intensity signal 260, the detection threshold value 275 must also include an offset in accordance with the estimated average of the selected receiver pair intensity signals 260. In a specific simulation based on the configuration depicted in FIG. 9 and FIG. 10, this offset is found to be 4.538 times the standard deviation of the digital pixel intensity signals 155, and thus it is appropriate to set the detection threshold value to (4.538+1.213) = 7.751 times the standard deviation of the digital pixel intensity signals 155. In embodiments, this process may be iterated continuously (omitting redundant receipt 785 of the constant false alarm rate target value), to adjust for changes in the environment. While this embodiment has advantages in that it collects digital pixel intensity signals 155 that are already produced in the method set forth above, and in that the collection of the 10,000 samples can be achieved quickly given that samples can be collected in parallel for all of the digital pixel intensity signals 155 simultaneously, which, with the hardware configuration depicted in FIG. 9 and FIG. 10, would mean that 32 samples can be accumulated in parallel, there is a draw back in that samples must be collected from each of the individual pixel detectors 140, which are disposed separated from each other, requiring wiring from to collect these samples from disparate locations to a centralized location, which could interfere with low size, weight, power, and cost (SWaP-C) objectives.

Another contemplated embodiment of a method for setting the detection threshold value 275, which solves the issue of collecting samples from disparate locations, is depicted in FIG. 13B. As opposed to the embodiment set forth above in relation to FIG . 13A, wherein pixel intensity signals 150 were sampled, in this embodiment the selected receiver pair intensity signal 260 is sampled, at a rate of, for example, 100 MHz, and the samples are stored 710 in a memory. After, for example, 10,000 samples have been stored, a known statistical algorithm is used to calculate 715 the standard deviation and mean of the selected receiver pair intensity signals 260 that have been stored. A constant false alarm rate target value is received 720. In embodiments, this reception 720 may be performed prior to the sampling and storing 710, while sampling and storing 710, or after sampling and storing 710. Using a known statistical algorithm or normal probability lookup table, the number of standard deviations for a threshold value to produce the targeted constant false alarm rate is identified 725, and the calculated 715 standard deviation is multiplied 730 by the identified 725 number of standard deviations, and the mean value of the samples is added thereto, to thereby calculate 735 an appropriate detection threshold value 275, which is then set 740 in the comparator 280.

While this embodiment has advantages in that it is based on known statistical techniques, and is calculated based on the selected receiver pair intensity signals 260, producing the advantage that the signals from the individual pixel detectors 140 have already been aggregated into a central location before use in this step thereby preventing the need for additional interconnections between the optical receivers 100, this embodiment has drawbacks in that the statistical calculations are complex and time-consuming and also require storage of a large number of sample values, resulting in high overhead, interfering with low size, weight, power, and cost (SWaP-C) objectives.

Another contemplated embodiment of a method for setting the detection threshold value 275, which solves the issue of having to carry out complicated statistical calculations, is depicted in FIG. 13C. A constant false alarm rate target value is received 855, and a threshold value is initialized 860 to zero, while the contents of an accumulator shift register (counting circuit) are cleared to zero. Note that in embodiments this initialization is not absolutely necessary. In the explanation for this embodiment, the accumulator shift register is assumed to be a 100,000-bit accumulator shift register, but there is no limitation thereto. The digitized pixel intensity signal 155 from each pixel detector 140 is sampled 865. Given the nature of this embodiment, this sampling may be achieved very quickly, where in embodiments this sampling may be carried out at 100 MHz, which sampling, in embodiments, may cycle through each of the 32 digitized pixel intensity signals 155 contemplated in the configurations depicted in FIGS. 9 and 10. Each digital pixel intensity signal 155 is compared 870 to the threshold value, to store a “1” in the accumulator shift register if the signal is greater than the threshold value, or to store a “0” otherwise. The value of the accumulator shift register (“count value” that indicates how many “1” values are stored in the accumulator shift register) is subtracted from a predetermined value (where this value is determined to produce a desired constant false alarm rate), to calculate a difference. In this exemplary embodiment, 15,870 is used for the predetermined value. The selection of this predetermined value in this exemplary embodiment is because 15.870% of samples of a normally distributed population will exceed a threshold value that is one standard deviation from the mean, meaning that a threshold value that results in 15,870 of the 100000 values in the accumulator shift register being “1” would be one standard deviation from the mean, assuming that the samples are from a signal that has been de-meaned through a high-pass filter. Following this, in an embodiment the difference is divided by 2^9 and subtracted from the threshold value. The factor 2^9 has been determined through simulation to cause rapid convergence of the threshold value, without ringing. In an embodiment the processes for the sampling 865 through the subtraction 880 are iterated 885 for 500000 cycles, which, when sampling at 100 MHz, requires 5 msec. As found in simulations, this process adjusts the threshold value to converge quickly to within 1% of the standard deviation of the digitized pixel intensity signal 155. The threshold value here is a threshold value from which the detection threshold value 275 is to be calculated. In embodiments, after awaiting 500000 cycles or 5 msec, in embodiments the same multiplication 775, conversion 780, identification 790, multiplication 795, calculation 800, and setting 810 as were explained for the embodiment described using FIG. 13A may be performed to set the detection threshold value 275 based on this adjusted threshold value. This embodiment has the advantage of being deployable in extremely fast and simple circuitry, enabling rapid adjustments to changing conditions, while supporting low size, weight, power, and cost (SWaP-C) objectives. However, as with the embodiment described in relation to FIG. 13A, there is the need to sample signals from all of the optical receivers 100, requiring additional wiring from disparate locations, which becomes an encumbrance to low size, weight, power, and cost (SWaP-C) objectives.

Another contemplated embodiment of a method for setting the detection threshold value 275, one which solves the issue of having to carry out complicated statistical calculations while also avoiding the need for additional wiring between disparate locations, is depicted in FIG. 13D. As with the method explained using FIG. 13C, a constant false alarm rate target value is received 815, and the detection threshold value 275 is initialized 820 to zero, while the contents of an accumulator shift register are cleared to zero. In embodiments these initializing steps are not absolutely necessary. While in the explanation for this embodiment, the accumulator shift register is again assumed to be a 100,000-bit accumulator shift register, there is no limitation thereto. The selected receiver pair intensity signal 260 is sampled 825. In embodiments this sampling may be carried out at 100 MHz. Each sampled receiver pair intensity signal 260 is compared 830 to the detection threshold value 275, to store a “1” in the accumulator shift register if the signal is greater than the detection threshold value 275, or to store a “0” otherwise. The value of the accumulator shift register is subtracted from a value that is 100000 times the constant false alarm rate target value (which in this embodiment indicates a target number of detections per second). Note that, unlike the embodiment described in reference to FIG. 13C, there is no need to de-mean the selected receiver pair intensity signal 260, as this method adjusts the detection threshold value 275 appropriately regardless of the actual mean or standard deviation of the selected receiver pair intensity signal 260. Following this, in an embodiment the difference is divided by 2^9, and subtracted from the detection threshold value 275. In an embodiment, the processes for the sampling 825 through the subtraction 840 are iterated 885 for 500000 cycles, which, when sampling at 100 MHz, requires 5 msec. This process causes the detection threshold value 275 to be adjusted quickly to converge to within 1% of a threshold value that will be exceeded by the selected receiver pair intensity signal 260 at a rate that is equal to the constant false alarm rate target that was received 815, enabling use 850 of this adjusted threshold value as the detection threshold value 275 in the comparison 50 in the method explained using FIG. 11. This embodiment has the advantage of being deployable in extremely fast and extremely simple circuitry, enabling rapid adjustments to changing conditions, while supporting low size, weight, power, and cost (SWaP-C) objectives, without requiring difficult wiring.

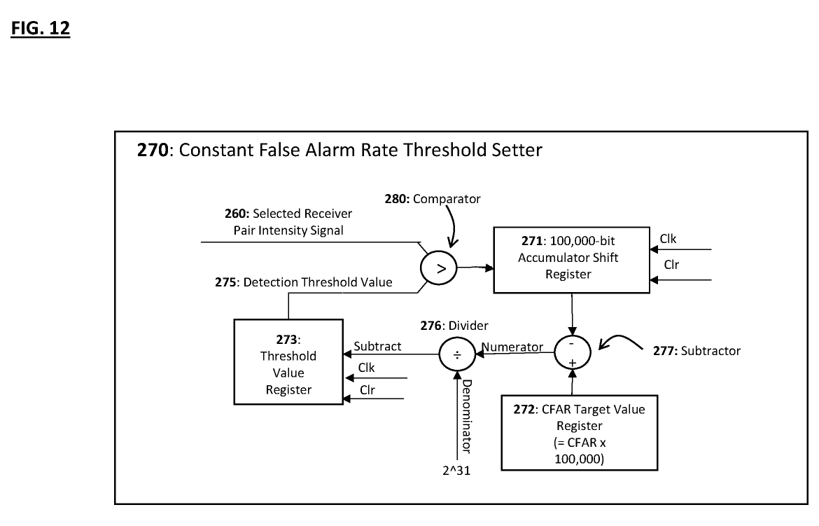

An embodiment of a simple feedback circuit by which to achieve the constant false alarm rate threshold setter 270 that performs the constant false alarm rate threshold setting method described using FIG. 13D will be explained below in reference to a simple circuit diagram in FIG. 12. The circuit comprises the comparator 280, described above, along with a 100,000-bit accumulator shift register 271, a CFAR target value register 272, a threshold value register 273, a divider 276, and a subtractor 277. The accumulator shift register 271 is cleared through assertion of a clear (Clr) bit. The accumulator shift register 271 is coupled to the comparator 280 and is configured to accept the output of the comparator 280 with every clock (Clk) cycle, and to output the register value to the subtractor 277. The CFAR target value register 272 is set in advance to a value that is equal to the CFAR target value times 100000. In embodiments this number may be varied, insofar as it is equal to the size of the accumulator shift register 271. The subtractor 277 subtracts the value of the accumulator shift register 271 from the value of the CFAR target value register 272, to produce a difference value. In embodiments the divider 276 divides the difference by 2^31 and inputs the result into a decrementing input of the threshold value register 273, which decrements by that quotient with every Clk cycle. The 2^31 devisor is selected, in embodiments, because it has been found in simulations to cause rapid convergence without ringing. The value of the threshold value register 273 is outputted, to the comparator 280, as the detection threshold value 275.Thus the simple circuit of this embodiment performs the method of the embodiment described using FIG. 13D, setting rapidly a threshold value that produces the design constant false alarm rate, without the need for complicated calculations or difficult wiring.

The correlator 300 will be explained next. The function of the correlator 300 is to examine detection signals to confirm that a reference detection signal 290 is a confirmed detection signal 340 that corresponds to an actual detection of laser energy from a designating laser burst scattered from the designated target 1100. The correlator 300 identifies cases where laser energy is actually detected, doing so by examining the timing with which signals (which may be false detection signals) are detected. If detection signals 290 are produced at intervals that match the period of repetition of the laser designator, then the correlator 300 identifies these detection signals 290 to be actual detections, and defines them as confirmed detection signals 340. In embodiments, the correlator 300 may use a temporal correlator as known to those skilled in the art. In embodiments, the correlator 300 may use a multistage correlator, comprising multiple stages of FIFO registers, as known to those skilled in the art, where the number of FIFO stages used determines a time window over which temporal correlation of detection signals 290 is examined. In embodiments a predetermined condition for confirming that a reference detection signal 290 is a confirmed detection signal 340 is that a predetermined number of detection signals 290 have been produced during a predetermined time window prior to a reference detection signal 290 at times that are at integer multiples of the period of repetition of a designator, used to designate a designated target 1100, prior to the reference detection signal 290. Note that in embodiments, in the correlator 300, the effective time window over which the correlation is examined is adjusted depending on the detected SNR, described above, where the time window for examining the correlation may be shorter with higher signal-to-noise ratios. Note that, in embodiments, the correlator 300 may be disabled, or a state may be set wherein a detection signal 290 is always deemed to be a confirmed detection signal 340, after a prescribed SNR has been detected.

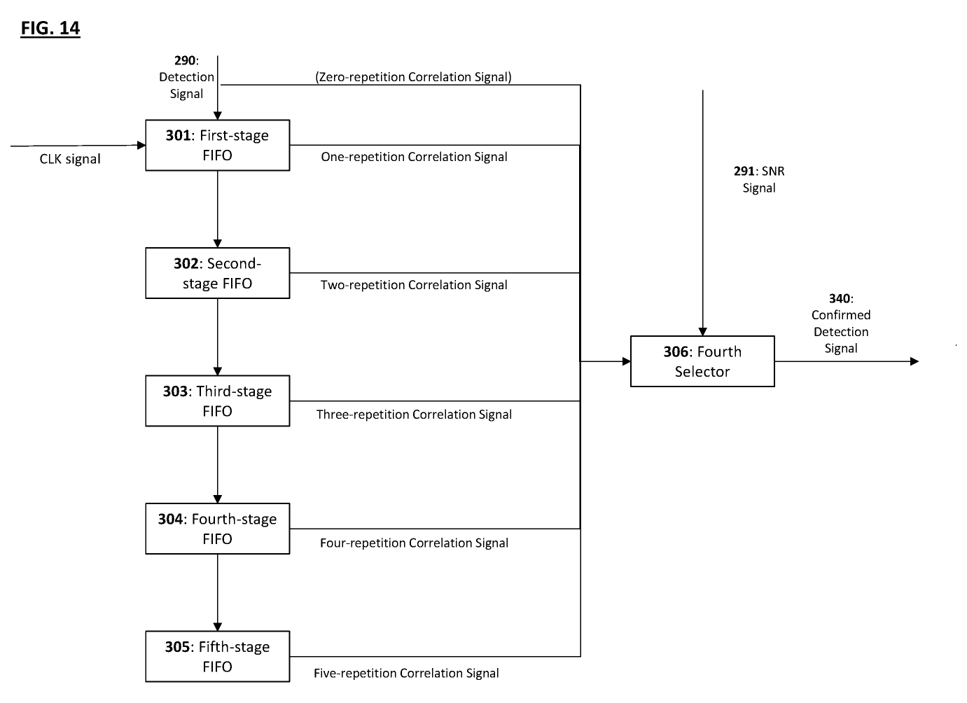

An embodiment of a correlator 300 will be explained in reference to FIG. 14. As depicted in FIG. 14, a correlator 300 according to an embodiment comprises a first-stage FIFO 301, a second-stage FIFO 302, a third-stage FIFO 303, a fourth-stage FIFO 304, and a fifth-stage FIFO 305, along with a fourth selector circuit 306. In embodiments, the first-stage FIFO 301 is configured to accept the detection signal 290 (a reference signal detection) and a CLK signal, not numbered, to store a timestamp when the detection signal 290 indicates that the selected receiver pair intensity signal 260 is greater than the detection threshold value 275, and to output the timestamp to the second-stage FIFO 302 when there already is stored, in the first-stage FIFO 301, a timestamp indicating that an earlier detection signal 290 was received at a time that was earlier by one period of repetition of the designator. When the first-stage FIFO 301 outputs this timestamp to the second-stage FIFO 302, the first-stage FIFO 301 also outputs, to the fourth selector circuit 306, a signal indicating that there is a correlation with a detection signal 290 that was one period of repetition earlier, and otherwise outputs a signal indicating that there is no correlation in this FIFO. In embodiments, this timestamp that is outputted by the first-stage FIFO 301 may be used as the detection signal 290. The second-stage FIFO 302 is configured to accept the timestamp from the first-stage FIFO 301, and to output the timestamp to the third-stage FIFO 303 when there already is stored, in the second-stage FIFO 302, a timestamp indicating that an earlier detection signal 290 was received at a time that was earlier by two periods of repetition of the designator. When the second-stage FIFO 302 outputs this timestamp to the third-stage FIFO 303, the second-stage FIFO 302 also outputs, to the fourth selector circuit 306, a signal indicating that there is a correlation with a detection signal 290 that was two periods of repetition earlier, and otherwise outputs a signal indicating that there is no correlation in this FIFO. Similarly, the third-stage FIFO 303 is configured to accept the timestamp from the second-stage FIFO 302, and to output the timestamp to the fourth-stage FIFO 304 when there already is stored, in the third-stage FIFO 303, a timestamp indicating that an earlier detection signal 290 was received at a time that was earlier by three periods of repetition of the designator. When the third-stage FIFO 303 outputs this timestamp to the fourth-stage FIFO 304, the third-stage FIFO 303 also outputs, to the fourth selector circuit 306, a signal indicating that there is a correlation with a detection signal 290 that was three periods of repetition earlier, and otherwise outputs a signal indicating that there is no correlation in this FIFO. The fourth-stage FIFO 304 and the fifth-stage FIFO 305 are configured similarly to output respective correlation signals to the fourth selector circuit 306, so redundant explanations are omitted.

Note that, through the structure described above, these first- through fifth-stage FIFOs 301 through 305 function to identify a number of correlations during a specific time window; specifically, if the fifth-stage FIFO 305 outputs a correlation signal, this means that, prior to the latest signal detection being inputted into first-stage FIFO 301 (a reference signal detection), signal detections were inputted at each integer multiple n (n=1 to 5) of the period of repetition of the laser designator, during a time window that is equal to 5 times the period of repetition of the laser designator. Conversely, if, for example, the fourth-stage FIFO 304 outputs a correlation signal, this means that, prior to the latest signal detection being inputted into first-stage FIFO 301 (a reference signal detection), signal detections were inputted at each integer multiple n (n=1 to 4) of the period of repetition of the laser designator, during a time window that is equal to 4 times the period of repetition of the laser designator.

In embodiments, the fourth selector circuit 306 is configured to accept the detection signal 290 and the SNR signal 291 from the comparator 280, and also the correlation signals from the first through fifth-stage FIFOs 301 through 305. In embodiments, the fourth selector circuit 306 is configured to compare the SNR signal 291 to first through fifth threshold values, not illustrated, the first threshold value being greater than the second threshold value, which is greater than the third threshold value, which is greater than the fourth threshold value, which is greater than the fifth threshold value, to selectively output, as the confirmed detection signal 340, the correlation signal from the fifth-stage FIFO 305 when the magnitude of the SNR signal 291 is less than the fifth threshold value, to selectively output, as the confirmed detection signal 340, the correlation signal from the fourth-stage FIFO 304 when the magnitude of the SNR signal 291 is greater than the fifth threshold value but less than the fourth threshold value, to selectively output, as the confirmed detection signal 340, the correlation signal from the third-stage FIFO 303 when the magnitude of the SNR signal 291 is greater than the fourth threshold value but less than the third threshold value, to selectively output, as the confirmed detection signal 340, the correlation signal from the second-stage FIFO 302 when the magnitude of the SNR signal 291 is greater than the third threshold value but less than the second threshold value, to selectively output, as the confirmed detection signal 340, the correlation signal from the first-stage FIFO 301 when the magnitude of the SNR signal 291 is greater than the second threshold value but less than the first threshold value, and to selectively output, as the confirmed detection signal 340, the detection signal 290 itself when the magnitude of the SNR signal 291 is greater than the first threshold value. This configuration of the correlator 300 in this embodiment reduces the time required to confirm the detection signal 290 as a confirmed detection signal 340 when the signal-to-noise ratio, as indicated by the SNR signal 291, is indicative of a strong return signal from the designated target, enabling greater responsiveness as range to the target diminishes as the platform approaches the target, without a concern that reducing the effective time window over which the correlation is examined will lead to erroneous confirmation of detection signals. In this configuration, the fourth selector circuit 306 acts as a controller that varies the time window overwhich correlations are examined.

Note that there is no limitation to exactly five stages of FIFOs in the correlator 300, but in embodiments the number of stages may be greater or less than five. In embodiments the correlator 300 may be of a different design, insofar as the functionality of confirming the detection signal 290 is based at least on temporal correspondence with earlier detection signals 290. Note that while in the embodiments set forth above same timestamp, of the most recent detection signal 290, was passed through the series of FIFOs, there is no limitation thereto, but rather the earlier correlated timestamp may be passed from each FIFO to the next, enabling each FIFO to have an identical design that examines for a correlation with a timestamp that is a single designator repetition earlier. Note that in other embodiments, the correlator may instead be structured from multiple stages of FIFO circuits, connected in series, configured to step the detection signal 290 therethrough, each FIFO circuit having a capacity able to store a number of bits equal to the number of samples during one repetition of the signal designator, combined with AND gates (not shown) to identify correlation of detections signals 290 that are outputted from the FIFO circuits.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the embodiments described above illustrate functional elements or method steps embodied in dedicated electronic circuits, it should be understood that such embodiments are provided by way of example only. The functional elements or method steps disclosed herein could be implemented in electronic circuits, including but not limited to logic produced through discrete components, circuits built into one or more integrated circuits, a Field-Programmable Gate Array (FPGA) or combinations of FPGAs, firmware, software executed on a specialized or general-use processor or a combination thereof, executable code stored in a Random Access Memory (RAM), Read-Only Memory (ROM), or other machine-readable medium, or transmitted over a network, or the like.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The reference numerals used in this disclosure are as follows:

100: Optical Receiver

110: Optical Waveguide

115: Optical Axis

117: Scattered Light 120: Bandpass Optical Filter

130: Linear Optical Detector Array

140: Pixel Detector

145: Signal Analysis Subsystem Provided in Association with Each Individual Optical Receiver

150: Pixel Intensity Signal

155: Digital Pixel Intensity Signal

160: Analog/Digital Converter

170: Adder (First Combiner)

180: Multipixel Intensity Signal

190: First Selector

200: Selected Multipixel Intensity Signal

205: Central Signal Analysis Subsystem Provided to Integrate the Signals from the Individual System Analysis Subsystems 145

210: Selected Multipixel ID Signal

220: Adder (Second Combiner)

230: Receiver Pair Intensity Signal

240: Second Selector

250: Third Selector (Pixel Location Identifier)

260: Selected Receiver Pair Intensity Signal

270: Constant False Alarm Rate Threshold Setter

271: 100000-bit Accumulator Shift Register

272: CFAR Target Value Register

273: Threshold Value Register

275: Detection Threshold Value

280: Comparator

290: Detection Signal

291: SNR Signal

300: Correlator (Temporal Correlator)

301: First-stage FIFO

302: Second-stage FIFO

303: Third-stage FIFO

304: Fourth-stage FIFO

305: Fifth-stage FIFO

306: Fourth Selector Circuit

310: Selected Receiver Pair ID Signal

320: Multipixel ID Signals for the Selected Receiver Pair

330: Target Vector Identifier

340: Confirmed Detection Signal

350: Switch

360: Target Vector

370: Guidance System

1000: Munition Platform

1010: Platform Barrel

1020: Canard

1100: Designated Target

1200: Target Vector

1202: Designator Platform

1204: Laser Beam

1206: Scattered Light

1300: Platform Pointing Direction

α: Deviation between Platform Pointing Direction and Target Vector

What is claimed is:

1. An optical seeker assembly in a semiactive laser guidance system, the optical seeker assembly comprising:
at least three optical receivers, each optical receiver comprising:
an optical waveguide configured to receive an optical signal;
a bandpass optical filter having a bandwidth, wherein a laser beam wavelength is within the bandwidth, and configured to filter the optical signal; and
a linear optical detector array optically coupled to the optical waveguide, the linear optical detector array comprising a plurality of pixel detectors to convert the optical signal and produce a plurality of pixel intensity signals;
a first combiner configured to combine pixel intensity signals from each of pluralities of adjacent pixel detectors to produce a plurality of multipixel intensity signals;
at least one first selector configured to select, from the plurality of multipixel intensity signals, the multipixel intensity signal indicating a greatest combined intensity, to produce a selected multipixel intensity signal;
a second combiner configured to combine selected multipixel intensity signals from mutually adjacent optical receivers to produce a receiver pair intensity signal;
a second selector to select, from a plurality of the receiver pair intensity signals, the receiver pair intensity signal indicating a greatest sum of intensities, to produce a selected receiver pair intensity signal;
a comparator configured to compare the selected receiver pair intensity signal to a detection threshold value, to identify a signal detection; and
a pixel location identifier configured to identify a pixel detector associated with the confirmed signal detection.

2. The optical seeker assembly of claim 1 further comprising:
a constant false alarm rate threshold setter configured to set the detection threshold value in accordance with a constant false alarm rate target.

3. The optical seeker assembly of claim 1 further comprising:
a target vector identifier configured to identify a vector to a target based on the identified pixel detector.

4. The optical seeker assembly of claim 2, wherein:
the constant false alarm rate threshold setter comprises a feedback circuit configured to adjust, based on a count value in a counting circuit, the detection threshold value or a threshold value from which the detection threshold value is to be calculated.

5. The optical seeker assembly of claim 4, wherein:
the constant false alarm rate threshold setter is configured to set the detection threshold value based on the adjusted threshold value.

6. The optical seeker assembly of claim 2, wherein:
the constant false alarm rate threshold setter is configured to set the detection threshold value based on a standard deviation that is calculated based on digitized samples of the pixel intensity signal, multipixel intensity signal, selected multipixel intensity signal, receiver pair intensity signal, or selected receiver pair intensity signal.

7. The optical seeker assembly of claim 1 further comprising:
a correlator configured to test correlation of the signal detections, produced at respectively different times, to identify as a confirmed signal detection a signal detection that satisfies a predetermined correlation condition.

8. The optical seeker assembly of claim 7, wherein:
the predetermined correlation condition is that of a predetermined number of signal detections have been produced during a prescribed time window, prior to a reference signal detection, at times that are at integer multiples of a period of repetition of a laser designator.

9. The optical seeker assembly of claim 8, further comprising:
a signal-to-noise ratio calculator for calculating a signal-to-noise ratio based on the intensity of the selected multipixel intensity signal and the detection threshold value or a value from which the detection threshold value is calculated; wherein
the length of the prescribed time window is determined by the signal-to-noise ratio, with the length of the prescribed time window being shorter for a greater signal-to-noise ratio than for a lesser signal-to-noise ratio.

10. The optical seeker assembly of claim 7, further comprising:
a switch to enable the identified vector to be used by a guidance system conditional upon identification of the confirmed signal detection.

11. The optical seeker assembly of claim 1, wherein:
the multipixel intensity signal is an intensity signal indicating the sum of the intensities for at least two adjacent pixels.

12. A correlator configured to identify a confirmed detection signal, comprising:
a plurality of stages of FIFO registers, each configured to receive and store a clock signal and, and to output a signal if an earlier clock signal from a prescribed time earlier is already stored in the applicable FIFO register; and
a selector to select the signal outputted from the FIFO register of a stage that is selected depending on a signal-to-noise ratio, wherein
the stage of the FIFO register that outputted the selected signal is earlier for a greater signal-to-noise ratio than for a lesser signal-to-noise ratio.

13. A computer program product including one or more non-transitory machine-readable mediums encoded with instructions that when executed by one or more processors cause a process to be carried out for confirming a detection signal for an optical seeker, the process comprising:
processing optical signals with a plurality of pixel detectors formed as a linear optical detector array into a plurality of pixel intensity signals;
converting the pixel intensity signals to digital signals and combining the digital signals from two or more adjacent pixel detectors into a plurality of multipixel intensity signals;
selecting from the plurality of multipixel intensity signals at least one selected multipixel signal representing the multipixel intensity signals having a greatest combined intensity;
combining the selected multipixel intensity signals and producing at least one receiver pair intensity signal;
selecting, from the at least one receiver pair intensity signal, a selected receiver pair intensity signal;
comparing the selected receiver pair intensity signal to a detection threshold value to identify a signal detection; and
identifying a pixel detector associated with the signal detection.

14. The computer program product according to claim 13, further comprising setting the detection threshold value in accordance with a constant false alarm rate target.

15. The computer program product according to claim 13, further comprising identifying a vector to a target based on the identified pixel detector.
